(19) United States
(12) Patent Application Publication
(10) Pub. No.: US 2007/0077810 A1
(43) Pub. Date: Apr. 5, 2007

(54) Floor care appliance equipped with detachable power cord

(76) Inventors: Nathan A. Gogel, Hustonville, KY (US); Yasushi Kondo, Okayama (JP)

Correspondence Address: KING & SCHICKLI, PLLC, 247 NORTH BROADWAY, LEXINGTON, KY, 40507, US

(21) Appl. No.: 11/543,553

(22) Filed: Oct. 5, 2006

Related U.S. Application Data
(60) Provisional application No. 60/723,719, filed on Oct. 5, 2005.

(51) Int. Cl. H01R 11/00

(52) U.S. Cl. 439/505

(57) ABSTRACT

A floor care appliance is equipped with a detachable power cord.

This application claims the benefit of U.S. Provisional Patent Application Ser. No. 60/723,719 filed on 5 Oct. 2005.

### TECHNICAL FIELD

The present invention relates generally to the floor care equipment field and, more particularly, to a floor care appliance equipped with a detachable electric power cord.

### BACKGROUND OF THE INVENTION

Vacuum cleaners, extractors and other floor care appliances are commonly utilized in residential and commercial settings to clean dirt and debris from rugs, carpets, hardwood, tile, vinyl, linoleum and other floor covering materials. Such appliances are used in a multitude of locations and settings. While some are battery powered, most are powered with electricity via a standard electrical wall outlet such as provided under the National Electrical Code as published by the National Fire Protection Association and as outlined in the standards of the National Electrical Manufacturers Association (NEMA) or the American National Standards Institute (ANSI).

Floor care appliances are generally equipped with a permanently attached electric power cord with an industry standard length of between 15-50 feet. Unfortunately, building code requirements relating to the placement of electrical wall outlets have varied over the years and continue to vary from place to place. As a consequence, many have found the standard length electrical cord provided on an appliance to be insufficient to reach from an available electrical wall outlet to an area of the floor they desire to clean. In such a situation the user has been forced to utilize an extension cord between the end of the standard electrical cord attached to the floor care appliance and the electrical wall outlet. Unfortunately, such standard and extension cords have a tendency to become disconnected during cleaning as the appliance is moved back and forth across the floor. This is very inconvenient for the user who must then reconnect the cord before proceeding with the cleaning operation.

The present invention relates to a floor care appliance equipped with a detachable electric cord. The manufacturer of the appliance provides a selection of cords of differing length so that the consumer may connect the electric cord of desired length to meet the needs of his or her particular application.

### SUMMARY OF THE INVENTION

In accordance with the purposes of the present invention as described herein, an improved floor care appliance is provided. The floor care appliance may be generally described as including a housing carrying a suction generator, a dirt collection vessel and an electric power cord receptacle. In addition the floor care appliance includes a first electric power cord having a first plug body adapted for detachable engagement with the electric power cord receptacle, a second plug body adapted for engagement with a standard electrical wall outlet and an electric line extending between the two plug bodies. The first plug body includes a first series of electrical conductors extending along a first longitudinal axis A and a connection with the electric line extending along a longitudinal axis B wherein axis A and B define an included angle of less than 180°, more typically between 150° and 30°, still more typically between 135° and 45° and most typically about 90°.

More specifically describing the invention, the electric power cord receptacle of the floor care appliance includes a cavity and the first plug body is at least partially received in that cavity. Further, the body may be substantially L-shaped. In addition the electric power cord receptacle includes a second series of electrical conductors that mate with the first series of electrical conductors when the first plug body is received in the cavity.

In accordance with another aspect of the present invention a magnetic fastener is provided for positively securing the first plug body to the electric power cord receptacle. The magnetic fastener may comprise a first magnet connected to either the receptacle or the first plug body. An element, constructed from a material attracted to the first magnet is provided in the other of the receptacle or first plug body. In another embodiment the element of the magnetic fastener is a second magnet.

In yet another possible embodiment the floor care appliance includes a releasable lock for securing the first plug body to the receptacle. That releasable lock may, for example, comprise a resilient fastener carried on the housing.

In accordance with another aspect of the present invention the floor care appliance includes a second electric power cord having a different length than the first electric power cord. The first and second power cords may be used interchangeably to connect the floor care appliance to a standard electrical wall outlet. The length of the power cord selected is determined by the application requirements of the user including, for example, the distance between standard electrical wall outlets and the shape and area of the floor to be cleaned. By selecting an electric cord of desired length, it is possible to eliminate the need to use an extension cord during the cleaning operation.

In accordance with additional aspects of the present invention the housing may include a nozzle assembly and a canister assembly. The nozzle assembly includes a suction inlet connected to the suction generator. A rotary agitator is carried by the nozzle assembly and extends across the suction inlet. Further, in one possible embodiment the canister assembly is pivotally connected to the nozzle assembly. Such an arrangement is commonly employed in, for example, upright vacuum cleaners and extractors.

In accordance with yet another aspect of the present invention a method is provided for improving the versatility of a floor cleaning appliance for different user applications. Such a method includes the steps of equipping the floor care appliance with a detachable electric power cord and allowing a user to select a detachable electric power cord of desired length when purchasing the appliance. Alternatively, the method may be described as including the steps of equipping the floor care appliance with a detachable electric power cord and providing a user with a choice of multiple detachable electric power cords of differing length.

In the following description there is shown and described preferred embodiments of this invention simply by way of illustration of some of the modes best suited to carry out the invention. As it will be realized, the invention is capable of other different embodiments and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of this specification illustrates several aspects of the present invention and together with the description serves to explain certain principles of the invention. In the drawings:

FIG. 1 is a schematical side elevational view illustrating one possible embodiment of the floor care appliance of the present invention;

FIG. 2 is a detailed schematical view illustrating the magnetic fastener for positively securing the first end of the detachable electric power cord to the electric power cord receptacle on the housing of the floor care appliance; and

FIG. 3 is a view similar to FIG. 2 but illustrating an alternative embodiment including a resilient fastener for securing the first end of the detachable electric power cord to the electric power cord receptacle of the floor care appliance.

Reference will now be made in detail to the present preferred embodiment of the invention, an example of which is illustrated in the accompanying drawings.

### DETAILED DESCRIPTION OF THE INVENTION

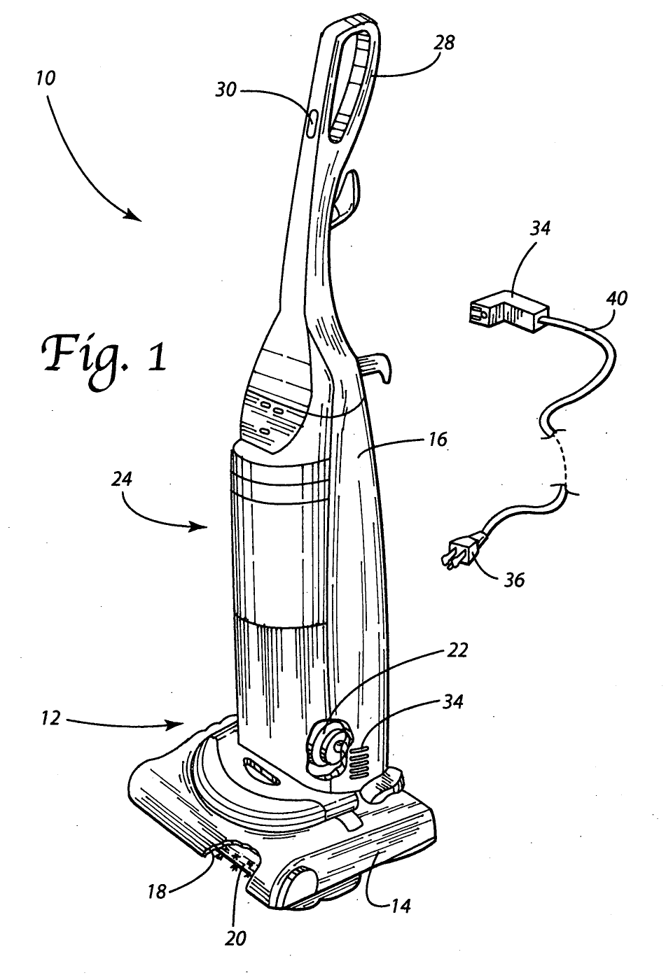

Reference is now made to FIG. 1 schematically illustrating the floor care or cleaning appliance 10 of the present invention. In the illustrated embodiment the appliance 10 takes the form of an upright vacuum cleaner. It should be appreciated, however, that this is for illustrative purposes only and that the present invention also includes other floor care or cleaning appliances such as extractors and canister vacuum cleaners.

As illustrated the appliance 10 includes a housing 12 comprising both a nozzle assembly 14 and a canister assembly 16. In the illustrated appliance 10, the canister assembly 16 is pivotally connected to the nozzle assembly 14. In a canister vacuum cleaner the nozzle assembly 14 and the canister assembly 16 would be separate components interconnected by a flexible hose for conveying air entrained with dirt between the nozzle assembly and the canister assembly.

As illustrated, the nozzle assembly 14 includes a suction inlet 18. In addition, a rotary agitator 20 is mounted on the nozzle assembly 14 and extends across the suction inlet 18. Wheels (not shown) connected to the housing 12 including either or both the nozzle assembly 14 and canister assembly 16 allow the appliance 10 to be moved smoothly and easily across the floor by the user.

The canister assembly 16 carries the suction generator 24 which may take the form of a fan and motor assembly, and the dirt collection vessel 26 which may take the form of a filter bag, a dirt cup or the like. In addition, the canister assembly 16 includes a control handle 28 and an actuator switch 30 for turning the appliance 10 on and off.

In operation, the rotary agitator 20 beats dirt and debris from the nap of an underlying carpet being cleaned. That dirt and debris is drawn into the suction inlet 18 by the airstream generated by the suction generator 24. That airstream entrained with dirt and debris is then drawn through the dirt collection vessel 26. The dirt and debris is trapped and collected in the vessel 26 while the air now cleaned of that dirt and debris is drawn over the motor of the suction generator 24 to provide cooling before being expelled back into the environment.

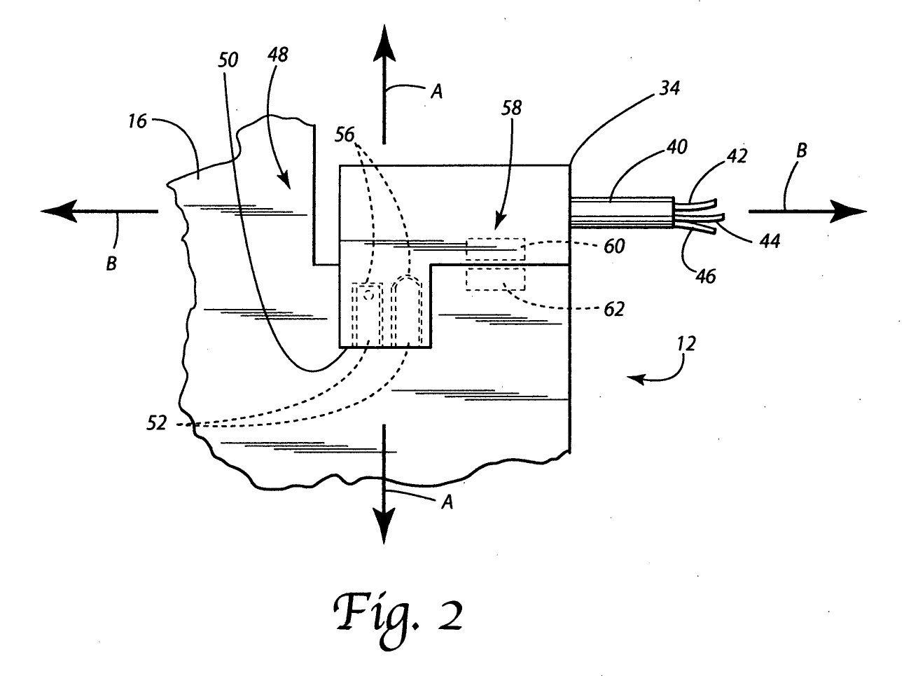

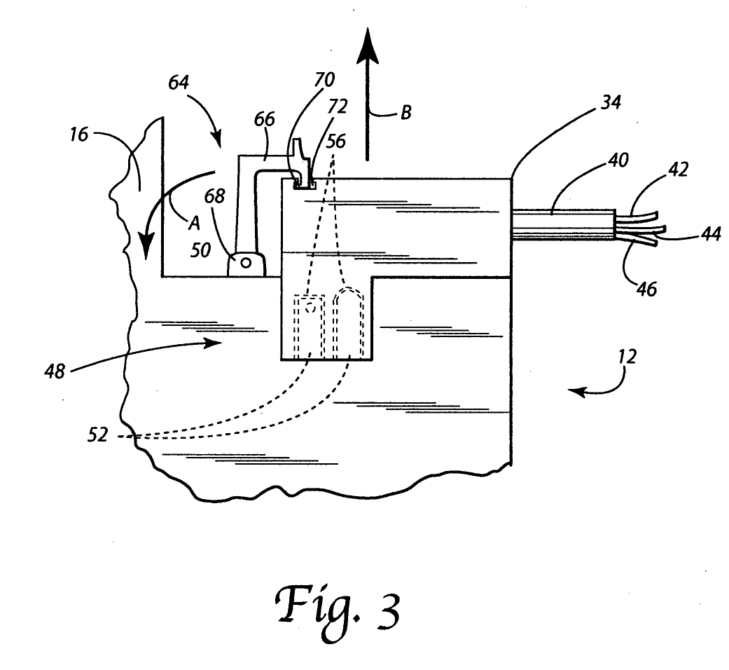

The appliance 10 is powered with electricity from a standard electrical wall outlet. An electric power cord 32 is provided to connect the appliance 10 to the electrical wall outlet. The electric power cord 32 includes a first plug body 34 that is connected to the appliance 10 and a second plug body 36 for connection to a standard electrical wall outlet. More specifically, the first plug body 34 includes a general purpose, nonlocking standard or conventional receptacle of the two pole, three wire type while the second plug body 36 includes a general purpose, nonlocking standard or conventional plug of the two pole, three wire type (see, for example, ANSI/UL 498-1980 and 498-1986). A flexible electrical line 40 extends between the first and second ends 34, 36 of the electric power cord 32. The line 40 includes two flexible electrical conductors 42, 44 and the electrical ground conductor 46 (see also FIGS. 2 and 3).

As should be appreciated, the electric power cord 32 is detachable from the floor care appliance 10. More specifically, an electric power cord receptacle, generally designated by reference numeral 48 is carried on the housing 12. In the illustrated embodiment the electric power cord receptacle 48 is carried on the canister assembly 16. It should be appreciated, however, that the electric power cord receptacle 48 could just as easily be carried on the nozzle assembly 14.

As illustrated, the electric power cord receptacle 48 includes a cavity 50 and a series of metal prongs 52 or electrical conductors extending upwardly from the bottom wall of the cavity forming an industry standard plug. As further illustrated in FIGS. 1 and 2, the first plug body 34 of the electric power cord 32 is substantially L-shaped. A series of electrical conductors 56 are provided in the plug body 34 and form an industry standard receptacle. The female conductors 56 correspond to the male conductors 52 of the electric power cord receptacle 48 and provide electrical connection between the male conductors and the conductors 42, 44 and 46 in the line 40 leading to the standard electrical wall outlet.

The electric power cord 32 is connected to the appliance 10 by inserting a leg of the L-shaped plug body 34 into the cavity 50 so that the male conductors 52 of the receptacle 48 are inserted and received in the female conductors 56 of the body (see FIG. 2). As should be appreciated, the female conductors 56 in the body 34 extend in a first direction or along a first longitudinal axis A illustrated vertically in FIG. 2. In contrast, the line 40 extending from the body 34 extends in a second direction or along a second longitudinal axis B illustrated horizontally in FIG. 2. Together, axis A and B define an included angle e of less than 180°. Typically the angle e is between 150°-30° and more typically between 135°-45°. In the illustrated embodiment, the line 40 extends in a direction substantially perpendicular to the female conductors 56. Advantageously, this helps prevent the first plug body 34 from inadvertently being disconnected from the cavity 50 during use of the appliance 10 as any pulling action produced from a tug on the line 40 is at a right angle to the direction of removal of the body from the cavity.

As illustrated in FIG. 2, an optional magnetic fastener, generally designated by reference numeral 58, may be provided to positively secure the first plug body 34 of the first electric power cord 32 in the power cord receptacle 48. The magnetic fastener comprises a first magnet 60 provided in the L-shaped body 34 while a second cooperating element 62, attracted to the first magnet 60, is provided in the housing 12 adjacent the cavity 50 of the receptacle 48 (of course, it should also be appreciated that the relative positions of the magnet 60 and element 62 may be reversed if desired). When properly connected the first magnet 60 overlies the element 62. In one possible embodiment, the element 62 is a second magnet. The fields of the two magnets 60, 62 are oriented so that the magnets 60, 62 are attracted to one another and thereby provide a positive force for holding the first plug body 34 of the electric power cord 32 in the cavity 50 of the receptacle 48.

In yet another alternative embodiment illustrated in FIG. 3, the appliance 10 may be equipped with a releasable lock generally designated by reference numeral 64. In the illustrated embodiment the releasable lock 64 comprises a resilient latch 66 pivotally connected by a trunnion 68 to the housing 12 and more particularly the canister assembly 16. As illustrated the latch 66 includes a locking tab 70 that is received in a cooperating groove 72 on the top of the first plug body 34 of the power cord 32. In this way the latch 66 serves to positively retain the body 34 in the cavity 50 and thereby prevents inadvertent disconnection of the power cord 32 from the appliance 10. The power cord 32 may, however, be easily disconnected by engaging the actuator 74 with a finger and biasing the latch 66 against the resilient memory of the material in order to remove the tab 70 from the groove 72 and thereby allow the latch to be pivoted in the direction of action arrow A away from the body 54. The body 54 is then withdrawn from the cavity 50 by pulling the body upward in the direction of action arrow B.

Of course, the appliance 10 may be equipped with a second or even more, additional electric power cords 32. Each such cord has a different length. Thus, the first cord 32 may, for example, have a length of twenty feet while the second cord 32 may have a length of forty feet. Both cords 32 are otherwise identical and connect to the receptacle 48 on the appliance 10 and the electrical wall outlet in the same manner. The user simply selects the cord 32 of desired length to meet his or her application needs. Cords of varying length may be selected by the user at the time of purchasing the floor appliance or at any subsequent time. By providing the user with a choice of cord length, the user may equip the vacuum cleaner to meet specific application needs and allow operation without an extension cord.

The foregoing description of a preferred embodiment of the present invention has been presented for purposes of illustration and description. It is not intended to be exhaustive or to limit the invention to the precise form disclosed. Obvious modifications or variations are possible in light of the above teachings. For example, the optional magnetic fastener 58 and releasable lock 64 may be used together. Further, while a power cord, receptacle and plug of the three wire type are described above, it should be appreciated that this invention is equally applicable to a floor care appliance equipped with a power cord, receptacle and plug of the two wire type.

The embodiment was chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally and equitably entitled. The drawings and preferred embodiments do not and are not intended to limit the ordinary meaning of the claims and their fair and broad interpretation in any way.

What is claimed:

1. A floor care appliance, comprising:
a housing;
a suction generator carried on said housing;
a dirt collection vessel carried on said housing;
an electric power cord receptacle carried on said housing; and
a first electric power cord having a first plug body adapted for engagement with said electric power cord receptacle, a second plug body adapted for engagement with a standard electrical wall outlet and an electric line extending between said first plug body and said second plug body;
wherein said first plug body includes a first series of electrical conductors extending along a first longitudinal axis A and a connection with said electric line extending along a second longitudinal axis B wherein axes A and B define an included angle of less than 180°.

2. The floor care appliance of claim l,wherein said included angle is between 150° and 30°.

3. The floor care appliance of claim 1, wherein said included angle is between 135° and 45°.

4. The floor care appliance of claim 1, wherein said included angle is about 90°.

5. The floor care appliance of claim 1, wherein said electric power cord receptacle includes a cavity and said first plug body is at least partially received in said cavity.

6. The floor care appliance of claim 1, wherein said first plug body is substantially L-shaped.

7. The floor care appliance of claim 6, wherein said electric power cord receptacle includes a second series of electrical conductors that mate with said first series of electrical conductors when said first plug body is received in said cavity.

8. The floor care appliance of claim 1, further including a magnetic fastener positively securing said first plug body to said electric power cord receptacle.

9. The floor care appliance of claim 8, wherein said magnetic fastener comprises a first magnet connected to one of said receptacle and said first plug -body.

10. The floor care appliance of claim 9, wherein said magnetic fastener includes a second magnet connected to the other of said receptacle and said first plug body.

11. The floor care appliance of claim 1, further including a releasable lock securing said first plug body to said receptacle.

12. The floor care appliance of claim 11, wherein said lock comprises a resilient fastener carried on said housing.

13. The floor care appliance of claim 1, wherein said floor care appliance includes a second electric power cord having a different length than said first electric power cord.

14. The floor care appliance of claim 1, wherein said housing includes a nozzle assembly and a canister assembly.

15. The floor care appliance of claim 14, wherein said nozzle assembly includes a suction inlet connected to said suction generator.

16. The floor care appliance of claim 15, wherein a rotary agitator is carried by said nozzle assembly and extends across said suction inlet.

17. The floor care appliance of claim 16, wherein said canister assembly is pivotally connected to said nozzle assembly.

18. A method for improving versatility of a floor cleaning appliance for different applications, comprising;
equipping said floor care appliance with a detachable electric power cord; and
allowing a user to select a detachable electric power cord of desired length when purchasing said floor care appliance.

19. A method for improving versatility of a floor cleaning appliance for different applications, comprising;
providing a user with a choice of multiple detachable electric power cords of differing length.
